(19) United States
(12) Patent Application Publication
(10) Pub. No.: US 2025/0308307 A1
(43) Pub. Date: Oct. 2, 2025

(54) ACCESS CONTROL GATE, ACCESS CONTROL SYSTEM AND METHOD OF OPERATING AN ACCESS CONTROL SYSTEM

(71) Applicant: KONE Corporation, Helsinki (FI)

(72) Inventors: Jouni Junes, Helsinki (FI); Visa Rauta, Helsinki (FI)

(73) Assignee: KONE Corporation, Helsinki (FI)

(21) Appl. No.: 19/233,789

(22) Filed: Jun. 10, 2025

Related U.S. Application Data
(63) Continuation of application No. PCT/FI2023/050006, filed on Jan. 3, 2023.

(51) Int. Cl. G07C 9/15

(52) U.S. Cl. CPC G07C 9/15

(57) ABSTRACT

The access control gate (1) for controlling flow of people in a building comprises at least one pole (2a, 2b) having a first end and a second end, and access control means (3a, 3b) configured to control access through the access control gate (1). The first end of the pole (2a, 2b) is configured to be attached to the ceiling (4) of the building and the access control gate (1) is configured to be moveable between at least a first position and a second position, wherein at least one of said positions is an operative position and the other position is an operative position or a storage position.

### TECHNICAL FIELD OF THE INVENTION

The present invention concerns an access control gate, as defined in claim 1, and an access control system comprising an access control gate. The invention further concerns a method of operating an access control system, as defined in another independent claim.

### BACKGROUND OF THE INVENTION

Different access control gates, which can be referred to as turnstiles, are often an essential part of controlling the flow of people in different buildings. Turnstiles are used, for instance, in office buildings, hospitals, educational facilities, hotels, airports and other transit centers. Turnstiles are used for preventing access of unauthorized persons to certain places and to guide and monitor the flow of people.

Turnstiles are typically provided with a rotatable tripod or with one or two turning leaf elements or arms to prevent passage of unauthorized persons. Certain access control gates do not comprise any physical barrier for preventing passage of unauthorized people, but the passage or approach of an unauthorized person can trigger an alarm.

Turnstiles can comprise different access control means for determining whether a person is authorized to pass through. Turnstiles can also be provided with different security features, for instance for preventing tailgating and crawling under the gate and for detecting children and baggage.

Many existing turnstile solutions have a large footprint. This is problematic in many places, for instance in high-rise buildings, where the lobby space can be very valuable. Also turnstiles with slim poles are known. A typical way of attaching such a pole to the floor is to arrange a strong steel tube in the concrete cast of the floor. This kind of attachment solution has many disadvantages. For instance, the steel tube needs to be installed in an early phase of the construction work, and because the tube extends above the finished floor level, it forms an obstacle during the construction work and also later during possible renovation of the building. Also, all the cabling or at least installation pipes for the cabling of the access control gates need to be installed in an early phase of the construction work. Furthermore, access control systems based on poles attached to the floor are very inflexible. Once the locations of the access control gates have been decided, moving of the gates is practically impossible or at least requires substantial amount of work.

### SUMMARY OF THE INVENTION

An object of the present invention is to provide an improved access control gate for controlling flow of people in a building. The characterizing features of the access control gate according to the invention are presented in claim 1. Another object of the invention is to provide an improved access control system. A further object of the invention is to provide a method of operating an access control system.

The access control gate according to the invention comprises at least one pole having a first end and a second end, and access control means configured to control access through the access control gate. The first end of the pole is configured to be attached to the ceiling of the building and the access control gate is configured to be moveable between at least a first position and a second position, wherein at least one of said positions is an operative position and the other position is an operative position or a storage position.

The access control gate according to the invention provides increased flexibility both during the construction work of the building and during the use of the access control gate. By attaching the poles of the access control gates to the ceiling, the exact locations of the access control gates can be decided in a later phase of the construction work. It is not necessary to provide the floor with fixing points, and the access control gates can thus be more easily moved between different locations. This allows taking the access control gates out of use when they are not needed, allowing thus undisturbed flow of people. Alternatively, or in addition, an access control gate can be moved between two or more different operative positions, for instance depending on whether more space is needed in the area of limited access or in the area of free access.

According to an embodiment of the invention, the pole is configured to be releasably attached to the ceiling. Releasable attachment allows the access control gate to be removed from the operative position and to be moved to another operative position or to a storage position.

According to an embodiment of the invention, the first end of the pole comprises quick-release means configured to cooperate with quick-release means arranged in the ceiling for attaching the pole to the ceiling. The quick-release means allow quick mounting and dismounting of the access control gate. The quick-release means could be operable tool-free.

According to an embodiment of the invention, the access control gate is configured to be attachable to power supply means arranged in the ceiling. By supplying power to the access control gate via the ceiling, no cabling needs to be installed in the floor. However, the access control gate could also be battery-powered, in particular if the access control gate has a low power demand, it is regularly moved between the operative position and a storage position allowing charging of the battery, and/or it is provided with a replaceable battery.

According to an embodiment of the invention, the pole is configured to have an operative position, where the pole is substantially vertical, and a storage position, where at least part of the pole is non-vertical. The non-vertical position can a substantially horizontal position. The access control gate does thus not need to be detached from the ceiling to move it to a storage position, but it can simply be rotated about a pivot point to free the floor surface. The access control gate can be moved to the storage position when smooth people flow is needed. The storage position can also be used for facilitating cleaning of the floor.

According to an embodiment of the invention, the access control gate comprises an actuator for moving the pole or part of the pole between the operative position and the storage position. The actuator can comprise, for instance, a motor or a pneumatic or hydraulic cylinder. The actuator allows moving of the access control gate by a single operator, and a single operator could move even several poles simultaneously.

According to an embodiment of the invention, the first end of the pole is movably attachable to a support rail mounted in the ceiling for moving the access control gate between said at least first position and second position. A support rail allows easy moving of the access control gate between different operative positions and/or between an operative position and a storage position.

According to an embodiment of the invention, the access control gate comprises a motor for moving the pole along the support rail. A motor allows easy moving of the access control gate by a single operator. However, the access control gate could be moved even without a motor or the motor could be arranged in the ceiling.

According to an embodiment of the invention, the access control means comprise a barrier element that is moveable relative to the pole to prevent and allow access through the access control gate. The barrier element is not necessary, but the access control means could be configured to indicate allowed or denied access by a visual signal and/or an audio signal. The access control gate could also be configured to solely count and/or identify the people passing the access control gate.

An access control system according to the invention comprises one or more access control gates defined above.

According to an embodiment of the invention, the access control system comprises a support rail mounted in the ceiling for moving the at least one access control gate between said at least first position and second position.

According to an embodiment of the invention, the access control system comprises a motor for moving the at least one access control gate along the support rail.

According to an embodiment of the invention, the access control system comprises an actuator for moving at least one pole or part of the pole of the at least one access control gate between a substantially vertical operative position and a non-vertical storage position.

According to an embodiment of the invention, the access control system comprises quick-release means attached to the ceiling and configured to cooperate with respective quick-release means of at least one pole for attachment and detachment of the pole.

According to an embodiment of the invention, the access control system comprises quick-release means attached to the ceiling at least in said first position and in said second position for receiving an access control gate to at least two different operative positions.

The method of operating an access control system defined above comprises the steps of
using the access control system in a first mode, where an access control gate of the system is arranged in a first operative position in the building, and
using the access control system mode in a second mode, where said access control gate is removed from the first operative position and moved to a second operative position or to a storage position.

### BRIEF DESCRIPTION OF THE DRAWINGS

Embodiments of the invention are described below in more detail with reference to the accompanying drawings, in which

FIG. 1 shows a group of access control gates according to an embodiment of the invention in an operative position,

FIG. 2 shows attachment means for the access control gates of FIG. 1,

FIG. 3 shows a group of access control gates according to another embodiment of the invention in an operative position,

FIG. 4 shows the group of access control gates of FIG. 3 some of the access control gates in a storage position,

FIG. 5 shows a group of access control gates according to another embodiment of the invention in an operative position,

FIG. 6 shows the access control gates of FIG. 5 in a storage position.

### DETAILED DESCRIPTION OF EMBODIMENTS OF THE INVENTION

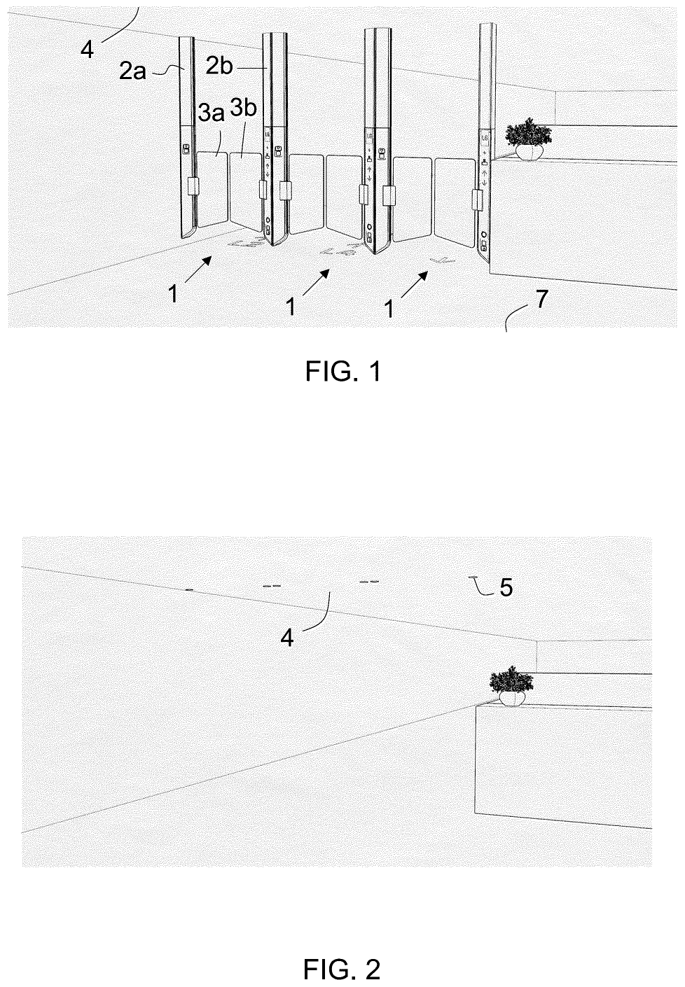

FIG. 1 shows a group of three access control gates 1 according to an embodiment of the invention. The term “access control gate” refers here to a gate that can be used for controlling and/or monitoring access of people from a room or an area to another room or area or for controlling flow of people. The access control gates 1 could also be referred to as turnstiles or access control devices. In the embodiment of FIGS. 1, the group of access control gates 1 forms an access control system. The access control system could comprise one or two access control gates 1 or more than three access control gates 1. The access control system could comprise two or more groups of access control gates 1.

The access control gates can be used, for instance, in office buildings; hotels; medical facilities; exhibition halls, concert halls, museums or other cultural facilities; airports, railway stations, subway stations, bus terminals or other transit centers; educational facilities or multi-purpose buildings.

The access control gates 1 comprise access control means configured to control access through the access control gates 1. In the embodiments of the figures, the access control means comprise barrier elements 3a, 3b for preventing passage of unauthorized persons. However, the term “access control gate” is used here to cover also such access control gates that do not comprise any barrier element. Such a gate could detect and possibly identify a person approaching or passing the gate. If the person is not authorized to pass the gate, denied access could be indicated by a visual or an audible signal or by both ways. The denied access can be indicated with means that are integrated into the gate. The gate could be provided with a display, light or other visual indicator for indicating whether access is denied or allowed. Alternatively, or in addition, the gate could be provided with a loudspeaker for giving an audible signal for indicating whether access is denied or allowed. Instead of or in addition to providing the gate with means for indicating whether access is denied or allowed, a separate device communicating with the gate could be used for indicating whether access is denied or allowed. For instance, a separate display, light or loudspeaker could be arranged in the vicinity of the gate. Alternatively, or in addition, the gate could communicate with a remotely located device. For instance, the gate could communicate with a display or other device located in a control room.

An access control gate without physical barrier elements could also be used, for instance, for monitoring the people passing the gate. Such monitoring could include identifying the people passing the gate and/or counting the number of people passing the gate.

In the embodiments of the figures, each access control gate 1 comprises two poles 2a, 2b and one barrier element 3a, 3b attached to each pole 2a, 2b. However, the access control gate 1 could also comprise a single pole and a single barrier element attached to said pole. Such an access control gate could be used, for instance, in a narrow corridor. Also, in a group of access control gates, each access control gate 1 could comprise one pole and one barrier element. In such a group, the barrier elements could be between the poles of two adjacent access control gates. At the ends of the group of access control gates, the barrier elements could be between a wall or other fixed construction and the pole of the respective access control gate. Each access control gate 1 could also comprise more than two poles 2a, 2b.

In the embodiments of the figures, the barrier element 3a, 3b is a plate element that is made of a polycarbonate. The plate element could also be made of some other plastic material. Alternatively, it could also be made of toughened and/or laminated glass. Instead of a plate element, the barrier element 3a, 3b could be for instance a frame made from tubular parts. The barrier element 3a, 3b could also have a shape of a boom or arm. In the embodiment of the figures, the rotation axis of the barrier element 3a, 3b is vertical. However, the rotation axis of the barrier element 3a, 3b could also be parallel to the direction in which the access control gate 1 is passed, especially if the barrier element was a boom or an arm. The barrier element 3a, 3b could also be a tripod, of which rotation axis is horizontal and transversal to the direction in which the access control gate 1 is passed. The barrier element could also be attached to the pole 2a, 2b via two or more points. The barrier element could be a retractable and foldable element.

In the embodiment of the figures, the upper edge of the barrier element 3a, 3b is at the height of approximately 1100 mm. The upper edge of the barrier element 3a, 3b can be arranged to be at a height of 800-1200 mm from the floor. However, the barrier element 3a, 3b could also extend higher.

Access control gates provided with a barrier element can be either normally open or normally closed. A normally closed access control gate opens when it is determined that the person at the gate is authorized to pass the gate. A normally open access control gate is closed if it is determined that the person is not authorized to pass the gate.

Access control gates can be provided with different sensors and devices for different purposes, for instance for determining whether a person is authorized to pass the gate and for ensuring safety and security. An access control gate can be provided with a reader for reading an identification tag for determining whether a person is authorized to pass the gate. The reader could be, for instance, a barcode reader, QR code reader, NFC reader or RFID reader. Alternatively or in addition, the access control gate could comprise means for biometric identification of people. The access control gate could comprise, for instance, a fingerprint scanner, an iris scanner or means for facial recognition.

Each pole 2a, 2b of the access control gate 1 has a first end and a second end. The first end is in an operative position of the access control gate 1 the upper end and the second end is the lower end of the access control gate 1. In the operative position of the access control gate 1, the poles 2a, 2b are substantially vertical. The first end of the pole 2a, 2b is configured to be attached to the ceiling 4 of the building where the access control gate 1 is used.

In the embodiments of the figures, in the operative position of the access control gate 1 the second ends of the poles 2a, 2b extend to the floor 7. The poles 2a, 2b can be configured such that the floor 7 carries at least part of the vertical load of the access control gate 1. That is, however, not necessary, but the vertical load can be carried solely by the ceiling 4. The lower end of the pole 2a, 2b does not need to extend to the floor 7, but the lower end of the pole 2a, 2b can be in the operative position of the access control gate 1 at a distance from the floor 7. The pole 2a, 2b could also be provided with a cover element contacting the floor 7 but not carrying substantial vertical load. If the access control gate 1 is configured such that also the floor 7 carries part of the vertical load, the floor 7 does not need to be provided with attachment means for the lower ends of the poles 2a, 2b, but the lower ends of the poles 2a, 2b could be arranged directly against the floor surface. The length of each pole 2a, 2b could be adjustable. For instance, the pole 2a, 2b could have a telescopic construction.

The access control gate 1 is configured to be moveable between at least a first position and a second position. At least one of said positions is an operative position. The other position can be either an operative position or a storage position. The term “operative position” refers to a position, in which the access control gate 1 can be used for controlling access through the gate 1.

The access control gate 1 can have two or more operative positions and/or two or more storage positions. The different positions can be positions where the whole access control gate 1 is located differently. However, the different positions can also be different rotational positions of the poles 2a, 2b or parts of the poles 2a, 2b. Part of the access control gate 1 can thus remain stationary when the access control gate 1 is moved from one position to the other position.

The access control gate 1 can be configured to be attachable to power supply means that are arranged in the ceiling 4. However, that is not necessary. The access control gate 1 does not need to comprise any electrical components, or the access control gate 1 could be provided with a battery powering the electrical components of the access control gate 1. Although it is beneficial to arrange the power supply means to the ceiling 4, the power supply means could also be arranged in the floor 7.

The access control gate 1 can be provided with a plug and socket-type connector for connecting the access control gate 1 to power supply means.

In the embodiment of FIGS. 1 and 2, the poles 2a, 2b are configured to be releasably attachable to the ceiling 4. The upper end of each pole 2a, 2b comprises quick-release means configured to cooperate with quick-release means 5 arranged in the ceiling 4 for attaching the pole 2a, 2b to the ceiling 4.

In the embodiment of FIGS. 1 and 2, the second position of the access control gate 1 is a storage position, where the poles 2a, 2b are detached from the ceiling 4, as shown in FIG. 2. The access control gates 1 can thus be stored in a storage room. However, the second position could also be another operative position. The ceiling 4 could thus be provided in another location with similar quick-release means 5 as in FIG. 2, which would allow moving the access control gates 1 to the other location.

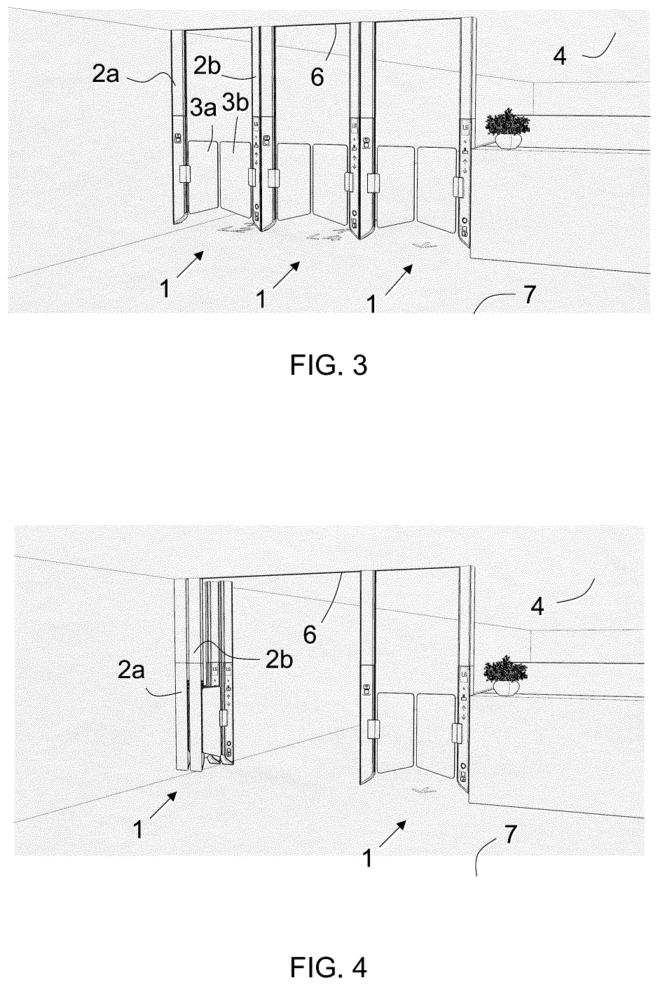

FIGS. 3 and 4 show another embodiment of the invention. The access control gates 1 of FIGS. 3 and 4 are similar to the access control gates of FIGS. 1 and 2. However, the upper ends of the poles 2a, 2b are not attached to the ceiling 4 by means of quick-release means. Instead, the ceiling 4 is provided with a support rail 6. The upper ends of the poles 2a, 2b are moveably attached to the support rail 6. In FIG. 3, all the three access control gates 1 are in operative positions. In FIG. 4, one of the access control gates 1 is in the operative position, but the other two access control gates 1 have been moved to storage positions. In the storage positions, the poles 2a, 2b of the access control gates 1 are arranged close to each other adjacent to a wall.

The access control gates 1 can be moved along the support rail 6 manually. Alternatively, each pole 2a, 2b could comprise a motor for moving the pole 2a, 2b along the support rail 6. Alternatively, motor or motors could be arranged in the ceiling 4. The access control system can comprise suitable force transmission means arranged between the motor and the poles 2a, 2b. In the embodiment of FIGS. 3 and 4, the support rail 6 is straight. However, the support rail 4 could also have some other shape. It could be configured to allow moving of the access control gates 1 between different spaces of the building.

The features of the embodiments of FIGS. 1-4 can be combined. The upper ends of the poles 2a, 2b could thus be attached to the support rail 6 releasably, for instance by means of quick-release means. That would allow two or more operative and/or storage positions of the access control gates 1. For instance, the access control gates 1 could have one storage position at an end of the rail 6 as shown in FIG. 4, and another storage position, where the poles 2a, 2b are detached from the rail 6. Also, the building could be provided with a similar support rail in a different location to allow the same access control gates 1 to be used in two alternative locations.

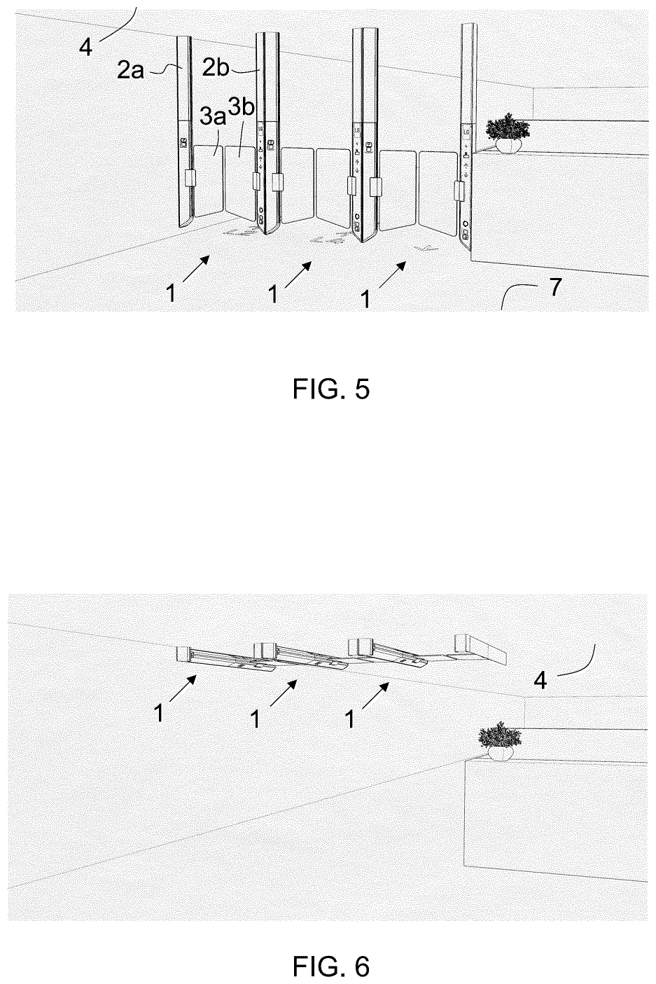

FIGS. 5 and 6 show a further embodiment of the invention. In the embodiment of FIGS. 5 and 6, the access control gates 1 are similar to the access control gates 1 of FIGS. 1 to 4. However, in the embodiment of FIGS. 5 and 6, the upper ends of the poles 2a, 2b are attached to the ceiling 4 such that the poles 2a, 2b can be rotatably moved between the operative position of FIG. 5 and the storage position of FIG. 6. In the operative position, the poles 2a, 2b are substantially vertical. In the storage position, the poles 2a, 2b are substantially horizontal. There is a pivot point between the ceiling 4 and the upper end of each of the poles 2a, 2b. Each pole 2a, 2b is pivotable about the respective pivot point. The rotation axis of the poles 2a, 2b are substantially horizontal.

The access control system can comprise one or more actuators for moving the poles 2a, 2b between the operative position and the storage position. The actuators could comprise, for instance, one or more motors, pneumatic cylinders or hydraulic cylinders. Alternatively, the poles 2a, 2b could be moved between the operative position and the storage position manually. The poles 2a, 2b could also be spring-biased to the storage position. The access control system can comprise locking means for locking the poles 2a, 2b to the storage position and/or the operative position.

Instead of making the whole pole 2a, 2b pivotable about a hinge, only part of the pole 2a, 2b could be pivotable. The pole 2a, 2b could thus comprise two or more parts and the uppermost part could remain vertical also in the storage position. The pole 2a, 2b could thus be folded in the storage position.

The features of the embodiment of FIGS. 5 and 6 can be combined with the features of the other embodiments. The access control gates 1 of FIGS. 5 and 6 could thus be both pivotable and attached to a support rail 6 and/or they could be releasably attached to the ceiling 4.

The method according to the invention comprises the steps of using the access control system in a first mode, where an access control gate 1 of the system is arranged in a first operative position in the building, and using the access control system mode in a second mode, where the access control gate 1 is removed from the first operative position and moved to a second operative position or to a storage position.

The possibility to use the access control gates 1 in an operative position and in a storage position provides many benefits. Even in an open state of the access control gates 1, they have a slowing effect on the flow of people. By moving the access control gates 1 to the storage position, smooth flow of people is facilitated. For instance, in a concert or similar event the access control gates 1 may be needed only before the show. During the show the access control gates 1 can be moved to the storage position, thus allowing unobstructed exit from the venue.

In an exhibition hall, different space arrangements may be needed depending on the exhibition. If the access control system allows different operative positions of the access control gates 1, the access control gates 1 can be located in an optimal manner for each event.

The storage position may also facilitate cleaning of the floors. By moving the access control gates to the storage position, the floors can be easily washed using floor washing machines.

It will be appreciated by a person skilled in the art that the invention is not limited to the embodiments described above, but may vary within the scope of the appended claims.

1. An access control gate for controlling flow of people in a building, the access control gate comprising
at least one pole having a first end and a second end, and
access control means configured to control access through the access control gate,
wherein the first end of the pole is configured to be attached to the ceiling of the building and the access control gate is configured to be moveable between at least a first position and a second position, wherein at least one of said positions is an operative position and the other position is an operative position or a storage position.

2. An access control gate according to claim 1, wherein the pole is configured to be releasably attached to the ceiling.

3. An access control gate according to claim 2, wherein the first end of the pole comprises quick-release means configured to cooperate with quick-release means arranged in the ceiling for attaching the pole to the ceiling.

4. An access control gate according to claim 1, wherein the access control gate is configured to be attachable to power supply means arranged in the ceiling.

5. An access control gate according to claim 1, wherein the pole is configured to have an operative position, where the pole is substantially vertical, and a storage position, where at least part of the pole is non-vertical.

6. An access control gate according to claim 5, wherein the access control gate comprises an actuator for moving the pole or part of the pole between the operative position and the storage position.

7. An access control gate according to claim 1, wherein the first end of the pole is movably attachable to a support rail mounted in the ceiling for moving the access control gate between said at least first position and second position.

8. An access control gate according to claim 7, wherein the access control gate comprises a motor for moving the pole along the support rail.

9. An access control gate according to claim 1, wherein the access control means comprise a barrier element that is moveable relative to the pole to prevent and allow access through the access control gate.

10. An access control system comprising one or more access control gates according to claim 1.

11. An access control system according to claim 10, wherein the access control system comprises a support rail mounted in the ceiling for moving the at least one access control gate between said at least first position and second position.

12. An access control system according to claim 11, wherein the access control system comprises a motor for moving the at least one access control gate along the support rail.

13. An access control system according to claim 10, wherein the access control system comprises an actuator for moving at least one pole or part of the pole of the at least one access control gate between a substantially vertical operative position and a non-vertical storage position.

14. An access control system according to claim 10, wherein the access control system comprises quick-release means attached to the ceiling and configured to cooperate with respective quick-release means of at least one pole for attachment and detachment of the pole.

15. An access control system according to claim 14, wherein the access control system comprises quick-release means attached to the ceiling at least in said first position and in said second position for receiving an access control gate to at least two different operative positions.

16. A method of operating an access control system according to claim 10, the method comprising the steps of
using the access control system in a first mode, where an access control gate of the system is arranged in a first operative position in the building, and
using the access control system mode in a second mode, where said access control gate is removed from the first operative position and moved to a second operative position or to a storage position.

17. An access control gate according to claim 2, wherein the access control gate is configured to be attachable to power supply means arranged in the ceiling.

18. An access control gate according to claim 3, wherein the access control gate is configured to be attachable to power supply means arranged in the ceiling.

19. An access control gate according to claim 2, wherein the pole is configured to have an operative position, where the pole is substantially vertical, and a storage position, where at least part of the pole is non-vertical.

20. An access control gate according to claim 3, wherein the pole is configured to have an operative position, where the pole is substantially vertical, and a storage position, where at least part of the pole is non-vertical.
